(19) United States
(12) Patent Application Publication
(10) Pub. No.: US 2015/0339598 A1
(43) Pub. Date: Nov. 26, 2015

(54) AUTOMATED BEST RATE GUARANTEE

(71) Applicant: TRAVEL TRIPPER LLC, New York, NY (US)

(72) Inventors: Gautam LULLA, Stamford, CT (US); Joseph PARRILLA, Astoria, NY (US)

(73) Assignee: TRAVEL TRIPPER LLC, New York, NY (US)

(21) Appl. No.: 14/718,369

(22) Filed: May 21, 2015

Related U.S. Application Data
(60) Provisional application No. 62/001,266, filed on May 21, 2014.

(51) Int. Cl. G06Q 10/02; G06Q 30/02; G06Q 30/06

(52) U.S. Cl. CPC G06Q 10/02; G06Q 30/0601; G06Q 30/0222

(57) ABSTRACT

The method and system permits for searching of rates offered by travel accommodation providers and comparing the retrieved rates. The methodology searches both the host site and third party sites to obtain a result listing. Based on this listing, the rates between that of the host site and the third party site are compared for discrepancies between the same or similar listings. If a discrepancy is found that makes the offering on the third party site less expensive than is offered on the host site for the same or similar accommodations, a best rate guarantee methodology is triggered. This takes into account the accommodations and pricing of each listing and based on predetermined constraints enables automatic price matching, incentives, discounts, and so forth to encourage a user to select the host site's accommodation.

### CLAIM OF PRIORITY

This application claims the priority of U.S. Ser. No. 62/001,266 filed on May 21, 2014, the contents of which are fully incorporated herein by reference.

### FIELD OF THE EMBODIMENTS

This field of this invention and its embodiments relates to procuring travel accommodations, namely seamlessly searching direct sellers and third party sites for travel accommodation rates and comparisons. In particular, to a method of searching a number of databases and automatically price matching an externally located price in order to increase revenue for the travel accommodation provider (direct seller).

### BACKGROUND OF THE EMBODIMENTS

Online travel agencies (OTAs) have become commonplace when one desires to book a travel accommodation(s). As more and more people use OTAs to find the best price for a particular accommodation, the travel accommodation providers are struggling to retain and/or expand their customer base. Primarily, this is attributable to the favorable pricing listings of the OTAs, which has subsequently resulted in a decrease in revenue for the travel accommodation provider.

The consumer often has very little concern pertaining to the avenues and the mechanisms of securing an accommodation booking. They are simply motivated by one factor: money. The fact is OTAs often list an accommodation for less than what is advertised directly through the travel accommodation provider. These favorable price/rate listings are compounded by the rise in prominence of the meta-search engines, or content aggregators. These entities perform many of the same functions as an OTA, are able to consolidate present prices from a variety of OTAs and some travel accommodation providers. These meta-search sites search multiple third party travel accommodation web sites or online listings at once to provide the content of many to a consumer with only one search string. Thus, there needs to be a way to give the travel accommodation provider, such as a hotel, an opportunity to recapture business and revenue siphoned off by these entities.

One avenue to creating a loyal and sustainable base for direct bookings is to compete directly with the OTAs and content aggregators. In doing so, one must return to the overriding factor in driving consumer purchasing decisions: money. Travel accommodation providers, such as hotels, need to be afforded an opportunity to effectively and automatically match prices within a particular range in order to offer the same, if not better, rates on accommodations. Such avenues currently exist in some inferior shape or form, as hotels will often “price match” a price found elsewhere that is less expensive than what the hotel is offering directly for the same accommodation.

The problem arises when one reaches the “fine print” of such offers. The hotels and other providers place so many limitations on what qualifies for the price match, that it is usually implemented incorrectly or not at all. In addition, the process for qualifying for a “price match” guarantee is laborious and time consuming for the consumer as well as the travel accommodation provider. Thus, there needs to be a readily available system that can not only find the best rates for a particular travel accommodation, but will automatically price match a found rate when appropriate. The present invention and its embodiments meets and exceeds these objectives.

### Review of Related Technology:

U.S. Pat. 6,839,679 pertains to an automated pricing system. The system obtains inventory information, specifying the rates and/or availability of a plurality of travel arrangements, from one or more computer reservation systems. The inventory information is stored in a database along with one or more portfolios of information (relating to a travel agency and each business entity customer of the travel agency) that can be used to discount the listed rates of the travel arrangements. In response to a specific travel itinerary from a customer, the system automatically retrieves the inventory and/or discount information from the database and determines the lowest-priced, available travel arrangements conforming to the itinerary. Consequently, a travel agent using the system does not have to spend time manually determining the lowest-priced travel arrangements.

U.S. Patent Application 2014/0081678 pertains to a system which may include a processor coupled to a memory. The processor is capable of determining a hotel cluster and facilitate a first hotel reservation in response to receiving an indication that a user has selected a first hotel rate. The processor is also capable of monitoring rate oscillation and determining whether a second hotel rate is less than the first hotel rate. The processor is also capable of facilitating the second hotel reservation in response to determining that the second hotel rate is less than the first hotel rate. The processor is further capable of communicating a message to the user in response to facilitating the second hotel reservation. The processor is capable of canceling the first hotel reservation if the user has selected the second hotel reservation and canceling the second hotel reservation if the user has selected the first hotel reservation.

Various devices are known in the art. However, their structure and means of operation are substantially different from the present disclosure. Such implementations either search a particular site or collection of sites attempting to find the lowest rate for a travel accommodation. The other inventions also fail to solve all the problems taught by the present disclosure. The present invention and its embodiments provide a simple and effective way of offering discounts and automatically price matching to a consumer directly from a travel accommodation provider. At least one embodiment of this invention is presented in the drawings below and will be described in more detail herein.

### SUMMARY OF THE EMBODIMENTS

Generally, the present invention and its embodiments provides a booking engine interface related to securing travel accommodations. While the focus is on travel accommodations, the methodology could be applied to any number of fields of endeavor including general online shopping/purchases or any item that can be compared between competitors. The booking engine interface is intended to be hosted by a travel accommodation provider rather than a third party booking site or content aggregator.

When a user submits a query, the booking engine searches its own database as well as a number of third party databases under the query constraints. The results are compiled by the booking engine and compared to each other. The comparison takes place between preferably the same travel accommodation, or at least a substantially similar accommodation, found internally on the host site and externally on the third party site. The best rate guarantee module then analyzes the prices or rates to determine whether any pricing action should be taken by the travel accommodation provider to incentivize the user to book with the travel accommodation provider rather than the third party site.

The present invention and its embodiments provide for a computer implemented method for executing travel accommodation transactions comprising the steps of: a client sending a first query over a network to a booking engine, wherein the first query contains at least a pricing information request; the booking engine performing a search of a database associated with the booking engine, wherein the search is done within constraints of the first query; the booking engine performing a search of third party databases, wherein the search is done within constraints of the first query; the booking engine comparing at least pricing results of the booking engine search and pricing results of the third party search; determining if the pricing results are more or less expensive through the booking engine or the third party database; wherein if the pricing results through the booking engine are more expensive, then the price through the booking engine the price may be changed in response to the lower third party price.

In another embodiment of the present invention there is a non-transitory computer readable medium to provide an accommodation/services rate program having instructions stored thereon that when executed on a computer cause the computer to perform the steps of: querying a booking engine over a network, wherein the query is a user constructed search string that the booking engine uses to perform a search of a database associated with the booking engine, querying at least one third party database over a network, wherein the query is a user constructed search string that the searches the database of the least one third party; comparing results of the booking engine search and the third party search; determining if there are any discrepancies between the booking engine and the third party database results; and automatically adjusting at least one characteristic associated with the booking engine to encourage a user to select the booking engine over the third party result.

In general, the present invention succeeds in conferring the following, and other not mentioned, benefits and objectives.

It is an object of the present invention to provide a method that shifts revenue to travel accommodation providers from third party booking engines.

It is an object of the present invention to provide a method that automatically adjusts the price of a travel accommodation.

It is an object of the present invention to provide a method that utilizes content aggregators to deliver consistent, accurate results.

It is an object of the present invention to provide a method that provides consumers with a reputable price.

It is an object of the present invention to provide a method that gives the consumer a discount or incentive to make a travel accommodation selection.

It is an object of the present invention to provide a method that compares a number of pricing options for the same, a comparable, or substantially similar item.

It is an object of the present invention to provide a method that notifies travel accommodation providers of listing errors.

It is an object of the present invention to provide a method that notifies travel accommodation providers of non-competitive price listings.

### BRIEF DESCRIPTION OF THE DRAWINGS

FIG. 1 is a graphical overview of the methodology employed by an embodiment of the present invention.

FIG. 2 is a flowchart illustrating the best rate guarantee methodology.

FIG. 3 is a representation of a results screen in accordance with the methodology of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations.

One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.”

Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s))” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O.

In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like.

Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state.

The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx.

Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the cooling chest system, including temperature sensors, ice dispensers (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, ice maker, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation.

In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blu-ray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. The operating system may be one specifically optimized to be run on a mobile computing device, such as iOS, Android, Windows Phone, Tizen, Symbian, and/or the like.

An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components.

After a Domain Name System (DNS) resolution portion of an HTTP request is resolved to a particular information server, the information server resolves requests for information at specified locations on the controller of the present invention based on the remainder of the HTTP request. For example, a request such as “http://123.124.125.126/myInformation.html” might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Firefox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like.

The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

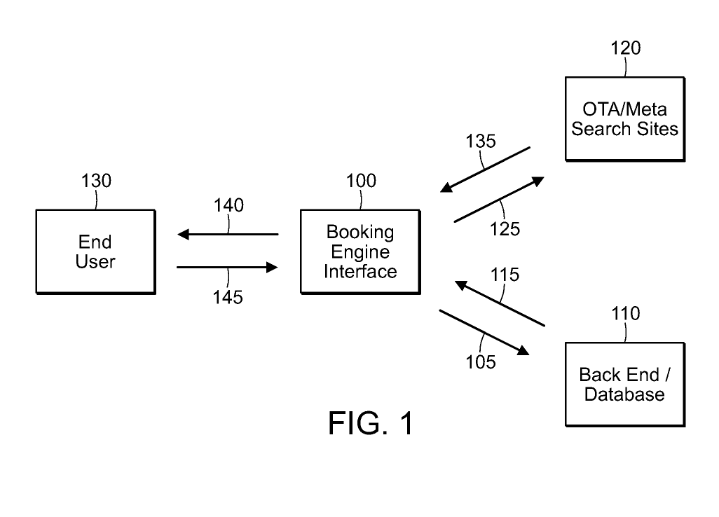

Referring now to FIG. 1, there is a booking engine interface 100 that is central to the methodology. The booking engine interface 100 is preferably hosted directly on a travel accommodation provider website rather than on a third party provider site. The booking engine interface 100 interacts with two main databases: a booking engine database/back end 110 and any number of online travel agency (OTA)/meta-search sites 120. The booking engine interface 100 takes the user inputted criteria 145 from an end user 130 and performs a first availability search 105 in its own database/back end 110. The back end 110 then returns the results of the first availability search 115 under the search constraints to the booking engine interface 100.

Concurrently, a second availability search 125 is performed of external databases of third party OTAs and meta-search sites 120 following the same criteria. The booking engine interface 100 then receives the results from the second availability search 135. The booking engine interface 100 then analyzes both sets of information by comparing the same or substantially similar listings between the third party OTAs and meta-search sites 120 and the database/back end 110. After the analysis is completed, the compiled results 140 are forwarded to the end user 130. The end user 130 can then make a decision based on the compiled results 140.

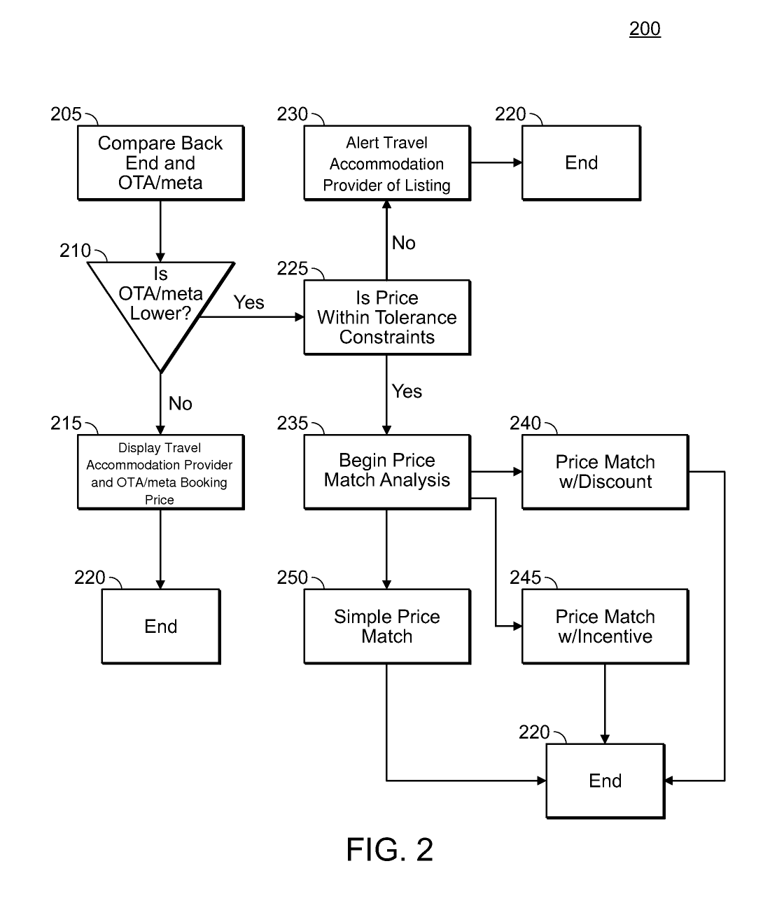

In FIG. 2 there is a flowchart outlining the methodology 200 associated with analyzing and comparing the search results returned from the backend and the OTA/meta-search sites.

The method 200 begins in step 205 with a comparison being performed by the booking engine of the search results retrieved from the booking engine's database and the OTA/meta-search sites.

In step 210, the system checks whether the pricing associated with the OTA/meta-search results are for the same or substantially similar travel accommodation and lower than those of the travel accommodation provider for the same accommodation. If the travel accommodation provider's pricing is lower, the method 200 moves to step 215 and the travel accommodation provider's pricing is shown in conjunction with the OTA/meta-search prices. A box or message may also be displayed assuring the customer that of the returned results, the pricing supplied by the travel accommodation provider is the lowest available price for the particular accommodation. As a result, the user will preferably select to book with the travel accommodation provider rather than through a third party site. In step 220, the method ends.

If in step 210 it is determined that the OTA/meta-search sites are offering a lower price than that of the travel accommodation provider for the same or substantially similar accommodation, the system checks to determine if the lower price is within the tolerance constraints implemented by the travel accommodation provider in step 225.

The tolerance constraints are a way for travel accommodation providers to manage and be alerted to extremely low price offerings for their accommodations and to correct any potential listing errors associated with those extremely low offerings. For example, if a hotel wanted to offer a certain room for $250/night the hotel may implement constraints setting the minimum price of that accommodation to $230/night. If an OTA is offering that accommodation for $200/night, then in step 230, the travel accommodation provider can be alerted. Such an alert will typically take the form of an email directed to the manager, department, etc. in charge of pricing and listings, however any form of notification is acceptable. The hotel can then take the proper corrective measures and the method 200 ends in step 220.

If in step 225, it is determined that the price or rate offered by the OTA/meta-search site is within the tolerance constraints set by the travel accommodation provider for that particular accommodation, the method 200 moves to step 235. In step 235, the price matching module begins an analysis based on the received pricing information, and other variables included in the original search sent by the end user.

In step 250, the price matching module compares the prices for the particular (same or substantially similar) accommodation found externally with that of the host site's (travel accommodation provider) and performs a simple price match. Such an action is typically taken if the any of prices are found to be within a narrow price band.

For example, a rental car company is offering a car for $37/day and through a third party OTA/meta-search site the same car from the same company is being offered at $36/day. The price matching module will let the customer know of the prices of the car, but will also reduce the price by $1 of the offering on the rental car company website to match that offered by the third party. This incentivizes the end user to select the rental car company's offering rather than that of the third party. The process then ends in step 220.

In step 240, the price matching module offers a price match with an additional discount. In this instance, the price matching module may calculate a difference in pricing between an externally located accommodation listing and a corresponding accommodation on the host site. The price of the travel accommodation provider's listing is set to match that of the OTA/meta-search offering. In addition, a further discount is offered to the end user. For example, in addition to the price match, the end user may be offered 10% off dinner at the hotel's restaurant. The exact discount and type is to be determined by the hotel and the system in calculating what should be offered to properly incentivize the end user.

In step 245, the price matching module offers a price match with an incentive for the end user. For example, the price matching module has calculated that a price match must be performed, but also recognizes from the user's information that the end user is a travel rewards member. The price matching module may then offer an incentive to book with the travel accommodation provider such as free rewards points that can be put toward future purchases including accommodation with the travel accommodation provider.

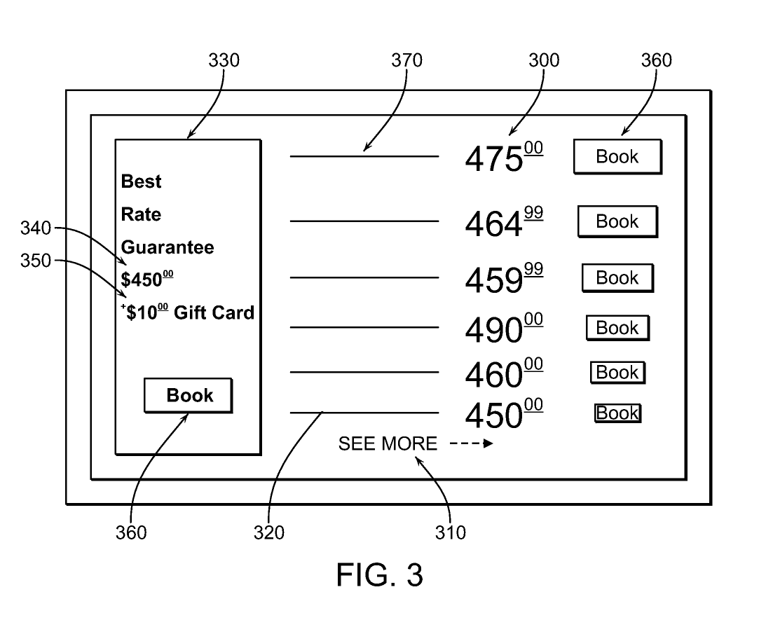

Referring now to FIG. 3, there is a representation of a results listing employing the present invention. There are a number of result listings 370 on one portion of the screen with the corresponding price 300 next to each of the result listings 370. The result listings 370 may include items such as the name of the accommodation, type, location, and other accommodation specific features. The result listing 370 may comprise any number of comparable or the same results from multiple third party sites related to the search string, however, in a preferred embodiment the results listing contains the exact travel accommodation as was returned from the host site simply via different channels, or third parties.

For example, an end user is looking for a hotel room for three (3) with a price of about $100/night to about $150/night. The host site searches its database and the third party OTAs and meta-search sites are searched under the same criteria for the same travel accommodation provider. Thus, while multiple results can be retrieved, the comparison and subsequent price matching methodology only takes place between the same accommodations found internally and externally. This provides multiple levels of comparison and potential savings to the end user. Thus, a user may find greater savings for a more expensive accommodation. In turn, they may also be offered different or the same price matching/discounts/etc. to book with the host site rather than the OTA/meta-search site.

Along an opposite side of the screen is the best rate guarantee box 330. The best rate guarantee 330 has a couple of components. There is a best rate price 340 which when compared to the any of the particular results listing 370 is typically at least equal to the lowest price found for that particular listing. In some instances, the best rate price 340 for a particular listing is lower than any of the prices found in the results listings 370 for that listing. In that case, the best rate guarantee box 330 would alert the end user to that effect. The best rate guarantee box 330 may also have an incentive or discount 350 along with the best rate price 340. There is also a booking option 360 to select the given listing for a reservation.

The results listings 370, or non-best rate pricing, are displayed in a typical list format with the list being sortable based on a number of features including price, location, rating, etc. There may be expandable/collapsible menus to show multiples of the same listing via different OTAs/meta-search sites. There may be an option to see the next page of results 310 or to expand the amount of result listings 370 shown on one page. The results listing 370 has a price 300 and a booking option 360 present with each of the listings.

In this instance, there is a listing 320 that matches the specifications and price listed of the best rate guarantee price 340. This is the result of the best rate guarantee price 340 being a price match in accordance with the methodology described in FIG. 2. The system, in this case, found that same listing 320 was lower in price than was would have normally been listed by the travel accommodation provider. The price was then matched to the lowest price, within the tolerance constraints, to that of the same result listing 320. Additionally, the system determined an incentive 350 should be offered as well. The incentive 350 shown is a gift card, but the incentive/discount given could be virtually any item and may relate directly to the travel accommodation provider or another entity.

Once a user has reviewed their options, the goal is have the listing from the travel accommodation provider selected by the end user. This, in turn, puts more money in the travel accommodation provider's pocket and returns business typically scavenged by the OTA/meta-search sites.

Generally, the travel accommodation providers and their websites have been broadly described and in some cases described as a hotel chain. However, the methodology is applicable to virtually any travel accommodation including but not limited to an airline ticket, cruise ship ticket, a hotel room reservation, a theme park ticket, a rental car reservation, an attraction ticket, a vacation rental, a tour reservation, or any combination thereof.

A large role in the price matching module as described in FIGS. 1-3 comes down to the travel accommodation provider and their preferences. This flexibility is instrumental in enabling a wide variety of accommodation providers to utilize the system as a whole. In order to price match, an externally located price must be lower than that offered by the travel accommodation provider for the same or at least a substantially similar accommodation. In a preferred embodiment of the present invention, the price match is done on the same accommodation. That is, the host site and the third party site are offering the same accommodation and the price/rate listed on the third party site is lower than that of the host site. The logic carried out therefrom is partly determined by the predetermined tolerance constraints set by the travel accommodation provider. The tolerance constraints can be set at varying levels that can influence the logic of the system in what is offered (i.e. discounts and incentives) and how such items are offered.

In some instances, the tolerance constraints can be tailored to a particular individual based on information provided by the end user when beginning the search process. For example, from information provided the system may be able to ascertain that the end user is rewards member or frequent customer. This places the end user in a certain class that can give them more perks or steeper discounts than an ordinary customer. Thus, while most customers may get a price match on an accommodation that is cheaper elsewhere, the rewards customer also receives “x” amount of additional rewards points or a special discount for booking with the travel accommodation provider.

Further, the system may be able to track the location of the end user based on global positioning system (GPS) information or any other various type of tracking information including metadata and internet protocol (IP) addresses. This gives the system the potential to make certain offers based on the location of the individual. In some instances, this can be used to incentivize people from certain locations to use that accommodation by offering a slightly lower price than what would have traditionally been offered, or offering a price match and a discount/incentive whereas the protocol would have normally called for a price match only for a person outside of the target location.

In addition, the tolerance constraints can be set to accommodate certain times and dates. In many instances, such as peak times of the week, or travel calendar it may not be desirable to offer certain price matches or certain discounts/incentives. Alternatively, this may also be the time to encourage consumers to book directly through the travel accommodation provider and increase the tolerance constraints to attract more customers. The system can be tailored to the needs of the travel accommodation provider. Inherently, the system makes these logic choices once the predetermined tolerance constraints are in place without outside checks.

Even yet, the tolerance constraints may be set to different levels within each of the above categories and other not named categories. These differing levels correspond to varying price offerings for a travel accommodation. A travel accommodation provider may have a minimum price for which they will not move below in price matching. A found offering at such a level by an OTA/meta-search site would trigger an alert and notification sent to the travel accommodation provider. Between the offering price by the travel accommodation provider and the minimum price or rate can be varying levels which may be matched or matched with variable discounts and incentives based on user information, time of day, month, etc. This adds another layer of flexibility and customization for the travel accommodation provider.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A computer implemented method for executing travel accommodation transactions comprising the steps of:
a client sending a first query over a network to a booking engine,
wherein the first query contains at least a pricing information request;
the booking engine performing a search of a database associated with the booking engine,
wherein the search is done within constraints of the first query;
the booking engine performing a search of at least one third party database,
wherein the search is done within constraints of the first query;
the booking engine comparing at least pricing results of the booking engine search and pricing results of the third party search;
determining if the pricing results are equal or more or less expensive through the booking engine or the third party database;
wherein if the pricing results through the booking engine are more expensive, then the price through the booking engine the price may be changed in response to the lower third party price.

2. The computer implemented method of claim 1 wherein the booking engine is hosted on a travel accommodation page on the network.

3. The computer implemented method of claim 1 further comprising the step of:
a user purchasing a travel accommodation based on compared or price modified results.

4. The computer implemented method of claim 3 wherein the travel accommodation is an airline ticket, cruise ship ticket, a hotel room reservation, a theme park ticket, a rental car reservation, an attraction ticket, a vacation rental, a tour reservation, or any combination thereof.

5. The computer implemented method of claim 1 wherein the price through the booking engine is lowered in response to the lower third party price.

6. The computer implemented method of claim 5 wherein the price is lowered within a predetermined range.

7. The computer implemented method of claim 1 wherein the price through the booking engine is lowered and at least one discount is given in response to the lower third party price.

8. The computer implemented method of claim 7 wherein the price and the at least one discount are defined by predetermined constraints.

9. The computer implemented method of claim 1 wherein if the third party price is outside the bounds of the predetermined range, then the price through the booking engine is not lowered.

10. The computer implemented method of claim 8 wherein the price and the discount are not offered if the third party price is outside the bounds of the predetermined constraints.

11. A non-transitory computer readable medium to provide services rate program having instructions stored thereon that when executed on a computer cause the computer to perform the steps of:
querying a booking engine over a network,
wherein the query is a user constructed search string that the booking engine uses to perform a search of a database associated with the booking engine,
querying at least one third party database over a network,
wherein the query is a user constructed search string that the searches the database of the least one third party;
comparing results of the booking engine search and the third party search; and
determining if there are any discrepancies between the booking engine results and the third party database results for the same item,
wherein if there is a discrepancy then at least one characteristic associated with the booking engine is automatically adjusting to encourage a user to select the booking engine over the third party result.

12. The non-transitory computer readable medium of claim 11 further comprising the step of:
automatically alerting a provider of the booking engine to the discrepancy between the results of the booking engine and the third party.

13. The non-transitory computer readable medium of claim 11 wherein the adjusting of the at least one characteristic is done within predetermined constraints.

14. The non-transitory computer readable medium of claim 13 wherein the price of a travel accommodation is adjusted.

15. The non-transitory computer readable medium of claim 14 wherein the adjusted price of the travel accommodation includes a secondary discount.
